(19) United States
(12) Patent Application Publication
(10) Pub. No.: US 2002/0073194 A1
(43) Pub. Date: Jun. 13, 2002

(54) Artificial fertilizing device for livestock

(76) Inventor: Yu-Hwa Liu, Dou Liu City (TW)

Correspondence Address: LARSON & TAYLOR, PLC, 1199 NORTH FAIRFAX STREET, SUITE 900, ALEXANDRIA, VA, 22314, US

(21) Appl. No.: 09/730,854

(22) Filed: Dec. 7, 2000

(51) Int. Cl. G06F 15/173

(52) U.S. Cl. 709/224; 714/47

(57) ABSTRACT

An artificial fertilizing device for livestock comprises an injection head made of soft material and including a chamber having an outlet defined in an end of the injection head. The chamber further includes an inlet having a diameter smaller than that of the chamber. The injection head further includes a groove that communicates with the inlet of the chamber. A bottom wall defining the groove has a non-circular countersink. A control rod includes a first end with an enlarged plug and a second end. The enlarged plug is movable between the chamber and the inlet of the injection head. The control rod further includes an engaging plate removably engagable with the non-circular countersink. The control rod includes an inner passage. The control rod further includes a transverse hole communicated with the inner passage. A hose is attached to the second end of control rod and communicated with the inner passage. An outer tube including an end releasably engaged in the groove of the injection head, the end of the outer tube including a pair of legs for pressing and thus retaining the engaging plate in the non-circular countersink. The pegs are movable to a position not pressing the engaging plate to allow removal of the engaging plate of the control rod from the non-circular countersink. The outer tube includes a longitudinal through-hole through which the hose extends.

### BACKGROUND OF THE INVENTION

1. Field of the Invention

The present invention relates to an artificial fertilizing device for livestock, and more particularly to an artificial fertilizing device for livestock, such as pigs, thereby improving the pregnancy rate.

2. Description of the Related Art

Taiwan Utility Model Publication No. 99428, issued on May 16, 1988 and entitled “ARTIFICAL FERTILIZING DEVICE FOR LIVESTOCK”, discloses an artificial fertilizing device comprising a fertilizing tube, a soft plug, a rubber band, a rubber hose, and a squeezing bottle. The soft plug is mounted to an annular groove defined in an outer periphery of an end of the fertilizing tube. The rubber hose is attached to a front end of the fertilizing tube. Sperms contained in a bottle enter the vagina of a pig via the rubber hose and the fertilizing tube.

Taiwan Utility Model Publication No. 283934, issued on Aug. 21, 1996 and entitled “IMPROVED ARTIFICAL FERTILIZING DEVICE FOR PIGS”, discloses an artificial fertilizing device comprising an outer tube and an inner tube being extended through the outer tube, the outer tube having a front end with an auxiliary device attached thereto. Connected to a front end of the inner tube is an injection tube with a plurality of apertures, and a bead is connected to the injection tube.

In the above-mentioned patents, the fertilizing tube or the inner tube has an end that is inserted deeply into a position between the vagina and the opening of the cervix uteri, and the other end has a portion that is protruded beyond the vagina. Since the fertilizing tube or the inner tube has certain rigidity so as to be inserted to a deep of the vagina and the fertilizing tube or the inner tube must be remained in the vagina of the livestock (such as a pig) for up to fifteen hours to insure pregnancy, the pig carrying the rigid tube will feel extremely uncomfortable and have emotional problems and might even be injured. Movement of the pig may cause pre-falling of the fertilizing tube or movement of the soft plug or bead such that the sperms flow outward. As a result, the intended artificial pregnancy fails and the pregnancy rate is reduced.

### SUMMARY OF THE INVENTION

It is the primary object of the present invention to provide an artificial fertilizing device for livestock that can be easily guided into the vagina of a livestock (such as a pig), wherein only a soft tube is remained in the vagina of the pig to reduce discomfort and injury to the vagina and cervix uteri, thereby reducing the emotional problems resulting from discomfort. In addition, the pregnancy rate is improved by means of using the artificial fertilizing device in accordance with the present invention.

An artificial fertilizing device for livestock in accordance with the present invention comprises:

an injection head made of soft material and including a chamber having an outlet defined in an end of the injection head, the chamber further including an inlet having a diameter smaller than that of the chamber, the injection head further including a groove that communicates with the inlet of the chamber, a bottom wall defining the groove having a non-circular countersink;

a control rod including a first end with an enlarged plug and a second end, the enlarged plug being movable between the chamber and the inlet of the injection head, the control rod further including an engaging plate removably engagable with the non-circular countersink, the control rod including an inner passage, the control rod further including a transverse hole communicated with the inner passage, a hose being attached to the second end of the control rod and communicated with the inner passage; and

an outer tube including an end releasably engaged in the groove of the injection head, the end of the outer tube including a pair of legs for pressing and thus retaining the engaging plate in the non-circular countersink, the pegs being movable to a position not pressing the engaging plate to allow removal of the engaging plate of the control plate from the non-circular countersink, the outer tube including a longitudinal through-hole through which the hose extends.

The enlarged plug of the control rod is moved through the inlet into the chamber of the injection head to allow input of sperms into the chamber via the hose, the inner passage of the control rod, and the transverse hole After input of the sperms, the enlarged plug of the control rod is moved from the chamber to the inlet of the injection head such that the sperms in the chamber cannot flow back via the neck and the transverse hole of the control rod.

The hose further includes an end cap attached to an outer end thereof to thereby close the outer end of the hose.

Other objects, advantages, and novel features of the invention will become more apparent from the following detailed description when taken in conjunction with the accompanying drawings.

### BRIEF DESCRIPTION OF THE DRAWINGS

FIG. 1 is an exploded perspective view of an artificial fertilizing device for livestock in accordance with the present invention.

FIG. 2 is a longitudinal sectional view of the artificial fertilizing device in accordance with the present invention.

FIG. 3 is a sectional view similar to FIG. 2, illustrating disengagement of an outer tube after input of sperms.

FIG. 4 is a sectional view similar to FIG. 3, wherein the outer tube is removed.

### DETAILED DESCRIPTION OF THE PREFERRED EMBODIMENTS

Preferred embodiments in accordance with the present invention will now be described with reference to the accompanying drawings.

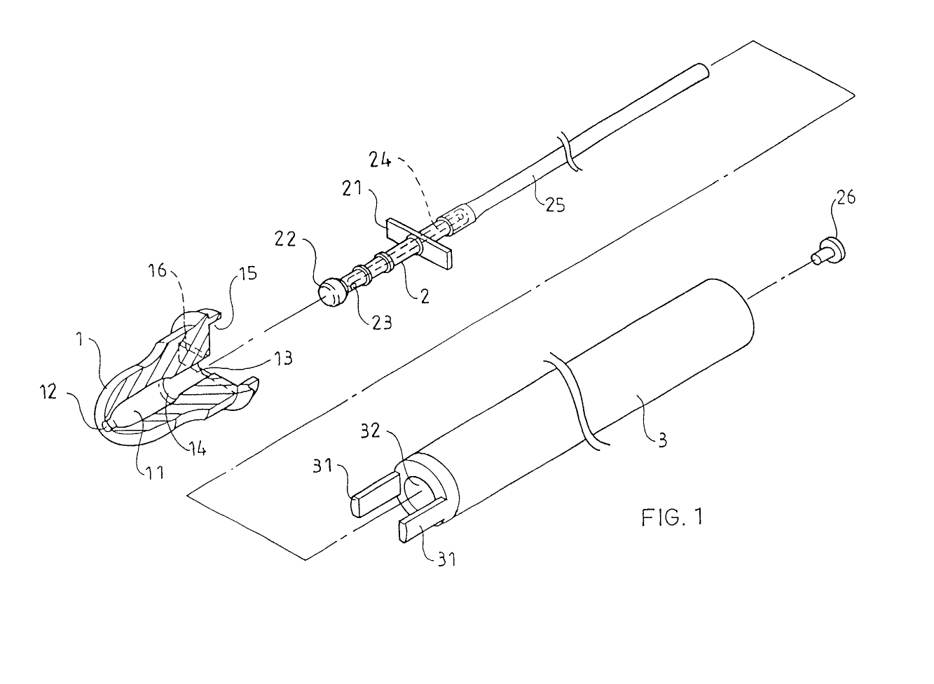

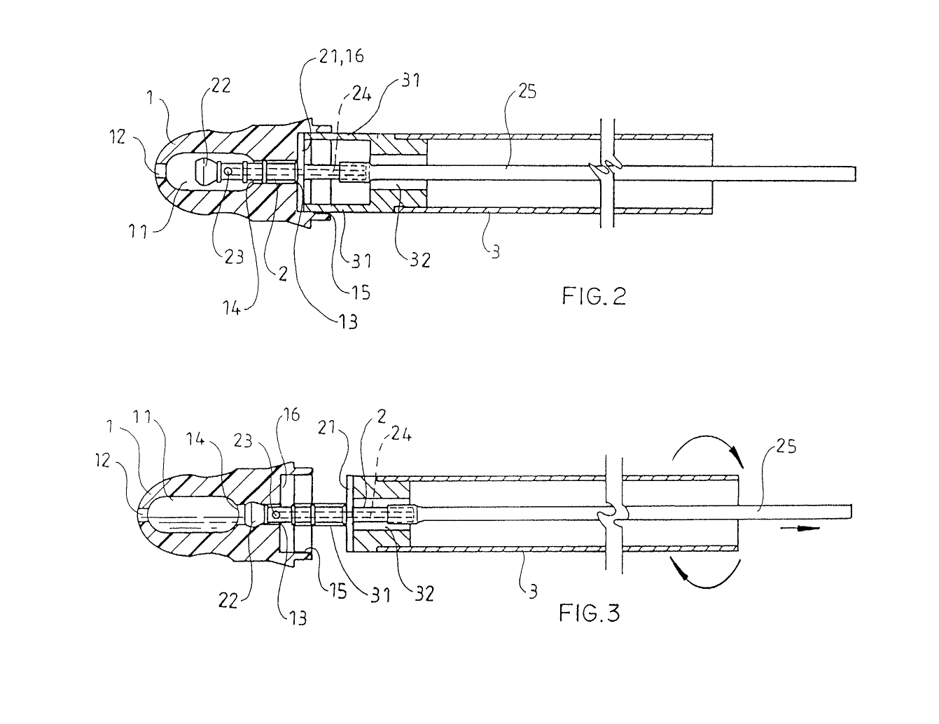

Referring to FIGS. 1 and 2, an artificial fertilizing device for livestock in accordance with the present invention generally includes an injection head 1, a control rod 2, and an outer tube 3. The injection head 1 can be of any conventional structure and is made from soft rubber material or the like. The injection head 1 includes a chamber 11 having an outlet 12 defined in an end of the injection head 1. The chamber 11 further has an inlet 13 through which an inner end of the control rod 2 is inserted into the chamber 11. The chamber 11 includes a neck 14 formed in the inlet 13; namely, an inner diameter of the neck 14 in inlet 13 is smaller than that of the chamber 11. The injection head I further includes a circular groove 15 that communicates with the inlet 13 of the chamber 11. A bottom wall defining the circular groove 15 has a non-circular countersink 16, which will be described later.

The control rod 2 includes an inner end that is inserted into the chamber 11 of the injection head 1. The control rod 2 further includes an engaging plate 21 that is releasably engaged with the countersink 16 of the injection head 1. The inner end of the control rod 2 inserted into the chamber 11 of the injection head 1 includes an enlarged plug 22 that may be in sealing contact with an inner periphery defining the neck 14. The control rod 2 further includes a transverse hole 23 adjacent to the enlarged plug 22. An inner passage 24 is defined in the control rod 2 and has an end communicated with the transverse hole 23. The other end of the inner passage 24 opens at an end face of an outer end of the control rod 2 that is opposite to the enlarged plug 22. A hose 25 is engaged with the outer end of the control rod 2. A conventional sperm container can be attached to the hose 25 for supplying sperms into the inner passage 24 via the hose 25.

The outer tube 3 is made of rigid material and includes a longitudinal through-hole 32 through which the hose 25 extends. An end of the outer tube 3 has a pair of legs 31 that can be inserted into the groove 15 of the injection head 11 for retaining the engaging plate 21 of the control rod 2 in the groove 15 in place. The outer tube 3 may be rotated to a position not pressing against the engaging plate 21 such that the engaging plate 2 may be moved to a space between the legs 31, thereby allowing subsequent longitudinal movement of the control rod 2.

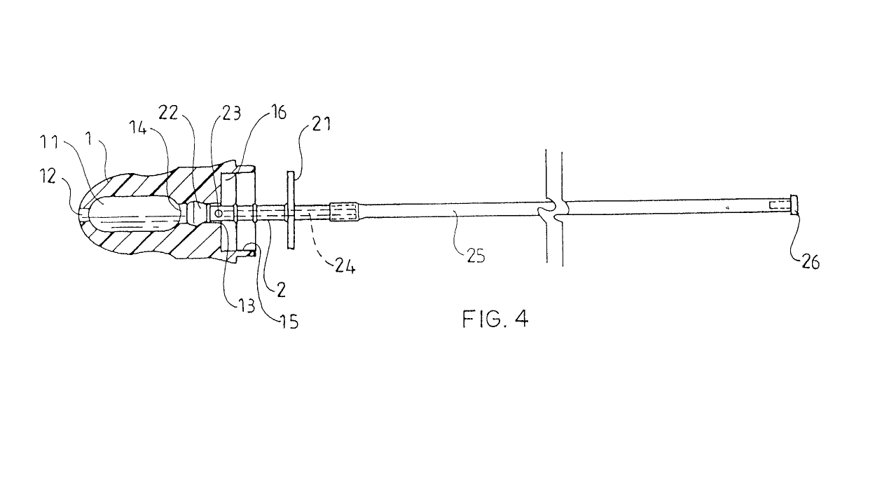

Referring to FIG. 2, in assembly, the enlarged plug 22 of the control rod 2 is inserted into the chamber 11 of the injection head 1 with the engaging plate 21 fittingly received in the countersink 16 and retained in place by the legs 31 of the outer tube 3 that extend into the groove 15 of the injection head 1. When the enlarged plug 22 is disengaged from the neck 14 of the injection head 1, the transverse hole 23 is not blocked, and the artificial fertilizing device can be easily inserted into the vagina of a livestock (such as a pig) and sperms can be inputted via the hose 25 into the chamber 11 of the injection head 1. Referring to FIG. 3, after input of the sperms, the outer tube 3 is rotated about 90 degrees such that the legs 31 are disengaged from the engaging plate 21. The hose 25 and the control rod 2 are pulled outward until the engaging plate 21 is in contact with an inner end face of the outer tube 3 from which the legs 31 project while using the outer tube 3 to retaining the injection head 1 in place Next, referring to FIG. 4, the enlarged plug 22 of the control rod 2 is in sealing contact with the inner periphery of the neck 14 such that the transverse hole 23 is blocked. Namely, the sperms in the chamber 11 cannot flow back via the transverse hole 23. If necessary, an end cap 26 may be provided to close an outer end of the hose 25. In this case, if the outer tube 3 is pulled outward, it can be removed from the control rod 2. Thus, only the injection head 1, the control rod 2, and the hose 25 are remained in the vagina of the pig. The hose 25 is made of soft material and thus may reduce discomfort and the resultant emotional problems. In addition, since the hose 25 is flexible, the enlarged plug 22 of the control rod 2 and the neck 14 of the injection head 1 have no positional displacement even though a portion of the hose 25 extends beyond the vagina of the pig. Thus, the transverse hole 23 is kept blocked to prevent reverse flow of the sperms in the chamber 11. According to the above description, it is appreciated that the injection head 1 can be easily inserted into the vagina of a livestock due to provision of the rigid outer tube 3 that can be removed after use. Only the injection head, the control rod, and the hose are remained in the vagina of the livestock such that injury to the vagina and cervix uteri of the livestock is prevented. Discomfort and emotional problems of the livestock are also prevented. In addition, during the pregnancy waiting period of about fifteen hours, only a small portion of the hose is exposed outside the body of the livestock when the injection head, the control rod, and the hose are remained in the vagina of the livestock and since the hose is flexible, the enlarged plug and the transverse hole can be maintained in their blocked positions while the livestock is moving or sleeping. Thus, leakage of the sperms is avoided, the pregnancy rate is thus improved.

Although the invention has been explained in relation to its preferred embodiment, it is to be understood that many other possible modifications and variations can be made without departing from the scope of the invention as hereinafter claimed.

What is claimed is:

1. An artificial fertilizing device for livestock, comprising:
an injection head made of soft material and including a chamber having an outlet defined in an end of the injection head, the chamber further including an inlet having a diameter smaller than that of the chamber, the injection head further including a groove that communicates with the inlet of the chamber, a bottom wall defining the groove having a non-circular countersink,
a control rod including a first end with an enlarged plug and a second end, the enlarged plug being movable between the chamber and the inlet of the injection head, the control rod further including an engaging plate removably engagable with the non-circular countersink, the control rod including an inner passage, the control rod further including a transverse hole communicated with the inner passage, a hose being attached to the second end of the control rod and communicated with the inner passage, and
an outer tube including an end releasably engaged in the groove of the injection head, the end of the outer tube including a pair of legs for pressing and thus retaining the engaging plate in the non-circular countersink, the pegs being movable to a position not pressing the engaging plate to allow removal of the engaging plate of the control plate from the non-circular countersink, the outer tube including a longitudinal through-hole through which the hose extends.

2. The artificial fertilizing device as claimed in claim 1, wherein the enlarged plug of the control rod is moved through the inlet into the chamber of the injection head to allow input of sperms into the chamber via the hose, the inner passage of the control rod, and the transverse hole; and
wherein after input of the sperms, the enlarged plug of the control rod is moved from the chamber to the inlet of the injection head such that the sperms in the chamber cannot flow back via the neck and the transverse hole of the control rod.

3. The artificial fertilizing device as claimed in claim 1, wherein the hose further includes an end cap attached to an outer end thereof to thereby close the outer end of the hose.
